(19) United States
(12) Patent Application Publication
(10) Pub. No.: US 2022/0195836 A1
(43) Pub. Date: Jun. 23, 2022

(54) WEIGHT AND DENSITY STABLE MATERIALS FOR FLOW CONTROL DEVICE FLOAT BODIES

(71) Applicant: Halliburton Energy Services, Inc., Houston, TX (US)

(72) Inventors: Chad William Glaesman, McKinney, TX (US); Charles Timothy Smith, Edgewood, TX (US)

(21) Appl. No.: 17/124,577

(22) Filed: Dec. 17, 2020

(51) Int. Cl. E21B 34/06; E21B 43/12

(52) U.S. Cl. CPC E21B 34/06; E21B 43/12

(57) ABSTRACT

A flow control device for a wellbore downhole tool, the device including a float body including a dicyclopentadiene thermoset resin, wherein the float body has a density in a range from about 0.6 to about 1.0 and has a volume swelling of 1 percent or less in the presence of a formation fluid produced in the wellbore over a production period of about 2 days or more. A method of manufacturing the flow control device is also described.

### BACKGROUND

Downhole tools used in the oil and gas industry can include flow control devices used to regulate the flow of formation fluids from a subterranean formation into a wellbore penetrating the formation. Some such devices include autonomous inflow control devices which are designed to autonomously discriminate between different types of formation fluids (e.g., gases, water, oil) for regulating access of the fluids to the interior of a wellbore, without the need for operator control.

### BRIEF DESCRIPTION

Reference is now made to the following descriptions taken in conjunction with the accompanying drawings, in which:

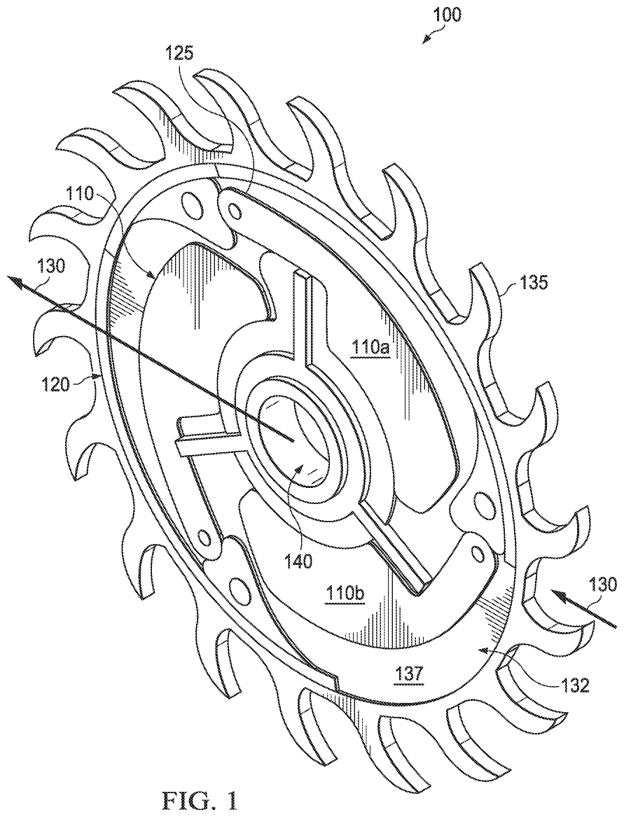

FIG. 1 presents a schematic diagram of an example flow control device of the disclosure in accordance with the principles of the present disclosure;

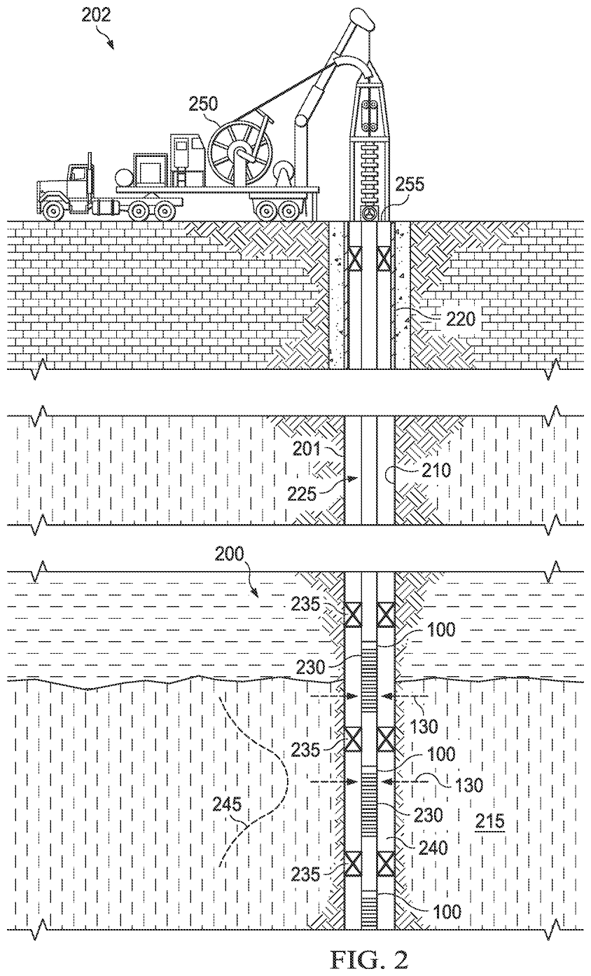

FIG. 2 presents a schematic cross-sectional view of an example flow control device of the disclosure, implemented for a wellbore downhole tool in a wellbore; and

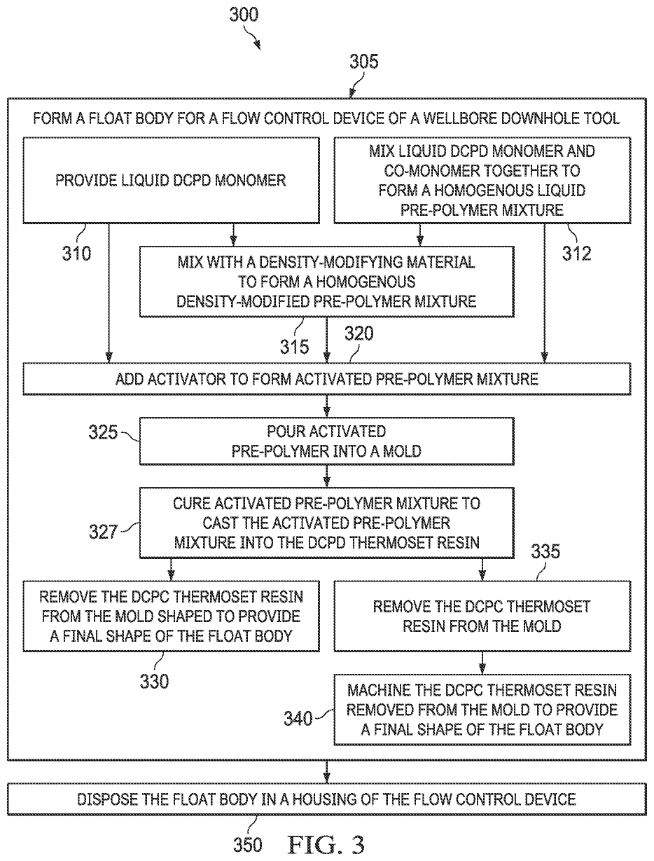

FIG. 3 presents a flow diagram of selected steps of an example method of manufacturing method of manufacturing a flow control device for a wellbore downhole tool, including any embodiments of the float body disclosed herein, in accordance with the principles of the present disclosure.

### DETAILED DESCRIPTION

As part of the present invention, we recognized certain problems associated with autonomous flow control devices that use density differences between water and oil to open or close off the fluid flow. Such devices often rely on the use of a float body to control flow based on the density differences between gases, oil or water to open or close off the fluid flow in the device.

The float body disclosed herein, is composed of a material having a density that is at or below the density of water or one that can be further modified to adjust the density, and is resistant to absorption of both hydrocarbon and water based fluids so that the geometry and density are stable, which is important to maintaining constant density in a downhole environment.

We discovered that float bodies composed of material which include a dicyclopentadiene (DCPD) thermoset resin can provide several advantages over other conventional polymer materials used to form the float body. For instance, we discovered that float bodies made of, or including, DCPD thermoset resins are resistant to the absorption of water-based formation fluids. In particular, when used below their glass transition temperature (Tg, e.g., about 150 to 200° C. in some embodiments), such float bodies do not readily absorb hydrocarbons present in formation fluids. Consequently, the use of DCPD thermoset resins facilitates making a float body that is both dimensionally and compositionally stable at downhole temperatures and pressures in a downhole oil production environment.

We also discovered that using a two-part liquid system to form the DCPD thermoset resin can facilitate casting the float body directly into its final shape, to thereby reduce manufacturing costs and complexity. Additionally, because DCPD thermoset resins have a density close to that of water these resins were found to make for a good base material for forming float bodies. Also, a two-part pre-polymer liquid system used to form the DCPD thermoset resins was conducive with mixing the liquid system with density-modifying material prior to curing, to allow fine tuning of the float body's density as needed for various fluid control applications in a flow control device.

A number of the features of the DCPD thermoset resin are in contrast to certain thermoplastics, such as polyether ether ketone (PEEK) or polyphenylene sulfide (PPS) polymers that were attempted to be used to form float bodies. For instance, such polymers which were found to have much higher densities than that of water, thereby making it more difficult to form a float bodies with an appropriate density over a broad range to differentiate between gases, oil or water in a flow control device. For instance, such thermoplastic polymers often require shear mixing and forming under high temperatures and pressures, which in turn, can damage or modify certain density-modifying material added to the melt polymer, thereby further limiting the options available to adjust the float body's density. For instance, such thermoplastics are often heat or geometrically unstable when exposed to downhole environmental conditions and/or can absorb hydrocarbon or aqueous fluids present in formation fluids, thereby resulting in a float body that does not maintain a constant density and/or shape in a downhole oil production environment.

One embodiment of the present disclosure is a flow control device for a wellbore downhole tool. FIG. 1 presents a schematic diagram of an example flow control device 100 with any embodiments of a float body 110 as disclosed herein. FIG. 2 presents a cross-sectional view of a wellbore downhole tool 200 of the disclosure, implemented in an example wellbore 201, the tool 200 including any of the embodiments of the flow control device and float body disclosed herein.

With continuing reference to FIGS. 1 and 2 throughout, as illustrated in FIG. 1, the device 100 includes a float body 110. The float body includes a DCPD thermoset resin. The float body has a density in a range from about 0.6 to about 1.0 and has a volume swelling of 1% or less in the presence of a formation fluid (e.g., FIG. 2, fluid 205) produced in the wellbore 201 over a production period of about 2 days or more, and in some embodiments, 4 days or more, 1 week or more, or 2 weeks or more.

The term density, as used herein, refers to the weight per unit volume (grams per cubic centimeter, gm/cc) of the float body at the temperature of the formation fluid, e.g., formation fluid in the wellbore environment in which the downhole tool is deployed during the production period.

The term volume swelling, as used herein, refers to the change in volume of the float body's volume when in the formation fluid as compared to when in air. One skilled in the pertinent art would be familiar with procedures to measure volume changes, e.g., such as using Archimedes' principle to measure the volume of formation fluid displaced when the float body is submerged in a sample, or simulated sample, of formation fluid.

The term production period, as used herein, refers to the time period when procedures to extract oil or gas from the wellbore are underway, including but not limited to pumping or injecting completion fluids into, and extracting formation fluids out of, various zones of the wellbore, e.g., as production fluids, and the regulation of such fluids by the flow control device, as familiar to those skilled in the pertinent art. In various embodiments, e.g., the production period can be a time span ranging from 2 days, 4 day, 1 week or 2 weeks.

The term formation fluid, as used herein, refers to any fluids from a subterranean formation that flow into a wellbore during the production period, and, can include gas, oil, or water. The formation fluid can include any combination of fluids extracted from the wellbore, or other fluids injected into the wellbore, e.g., drilling fluids, treatment fluids and completion fluids, to stimulate the extraction of oil from the formation.

The term DCPD thermoset resin, as used herein refers to homopolymers of dicyclopentadiene, or copolymers formed from dicyclopentadiene monomer and other monomers, via olefin ring-opening metathesis chain-growth polymerization.

In some embodiments, in order to provide structural stability in the wellbore environment, at least about 50 weight percent (wt %) of the float body is composed of the DCPD thermoset resin. In various embodiments the float body includes from about 50 to 60, 60 to 70, 70 to 80, 80 to 90 or 90 wt % or greater of the DCPD thermoset resin, with the balance including additives or density modifying materials as further disclosed herein. In some embodiments, the polymer resin component of the float body consists essential of the DCPD thermoset resin with only minor or trace amounts (e.g., 5 wt %, 1 wt %, 0.1 wt % or less) or other polymers present in the float body.

In some embodiments, the DCPD thermoset resin can be a homopolymer of dicyclopentadiene monomer. In some such embodiments, the DCPD thermoset resin used to from the float body can consist essentially of homopolymers of the dicyclopentadiene monomer with only minor or trace amounts (e.g., 5 wt %, 1 wt %, 0.1 wt % or less) of other monomers or additives present.

In other embodiments, to further adjust the glass transition temperature (Tg) of the float body, the DCPD thermoset resin can be a copolymer of dicyclopentadiene and tricyclopentadiene (TCPD). For example in some such embodiment the TCPD monomer (e.g., in an amount ranging from of about 1 to 30 wt %, weight per total weight of a pre-polymer mixture) can be combined with DCPD monomer (e.g., balance about 99 to 70 wt %, respectively) to provide a pre-polymer mixture which is then used to form the DCPD thermoset resin. In some such embodiments, the DCPD thermoset resin used to form the float body, can consist essentially of the copolymers of the of DCPD and TCPD monomers, with only minor or trace amounts (e.g., 5 wt %, 1 wt %, 0.1 wt % or less) of other monomers or additives present.

In still other embodiments, to further adjust the Tg and wear properties of the float body, the DCPD thermoset resin can be (or consist essentially of) a copolymer of dicyclopentadiene and other monomers including, as non-limiting examples: any one or combination of: dicyclopentadiene alkyl phenol and bisphenol resins, such as disclosed in U.S. Pat. No. 5,587,007; dicyclopentadiene phenol type epoxy resins, such as disclosed in CN110423536 patent application and/or in U.S. Pat. No. 10,538,660; alkyd resins, such as disclosed in CN110027063 patent application; polyester resins, such as disclosed in TW201945430 patent application; or elastomers, such as disclosed in US20060229374 patent application, all of these reference incorporated by references herein, in their entirety.

In some embodiments, the DCPD thermoset resin can be (or consistent essentially of) a blend of any such DCPD homopolymers or copolymers, e.g., the polymer blend ranging from about 10:90 to 90:10 ratios of first and second DCPD polymers.

Any such embodiments of the DCPD thermoset resin can further include additives such as binders, plasticizers, pigments, and dyes, or polymerization activators as familiar to those skilled in the pertinent arts. Non-limiting examples of activators/catalysts, include transition metals (e.g., salts or oxides of W, Mo, Re, Ru, Ti, including transition oxides and halides such as used in alkylating co-catalysts like Alkyl Zn or Alkyl Al), Hoveyda-Grubbs catalysts, or other ring-opening metathesis catalysts used in ring opening metathesis polymerization (ROMP), as familiar to those skilled in the pertinent art.

As noted, because the DCPD resin is resistant to the absorption formation fluids, the inclusion of the DCPD thermoset resin as part of the float body facilitates the float body being both dimensionally and compositionally stable. Consequently, the float body's density and volume size advantageously remains substantially constant throughout the production period, thereby allowing the flow control device to provide predictable and reliable control of fluid flow.

For instance, in some such embodiments, the float body's density changes by 5% or less, and in some embodiment, 1% or less, throughout the production period. As non-limiting examples, for various applications, the float body's density can be adjusted, as further disclosed herein, to any one selected densities of 0.60, 0.65, 0.70, 0.75, 0.80, 0.85, 0.90, 0.95, 1.0 or 1.05 gm/cc and that selected density changes by less than ±0.03 to ±0.05 gm/cc (e.g., a 5% or less change) or less than ±0.06 to ±0.1 gm/cc (e.g., a 1% or less change), during the production period. For instance, in some such embodiments, the float body's volume changes by 1%, 0.5% or 0.2% or less, throughout the production period.

In some embodiments, when the float body is configured as a liquid float, the density can be a value in a range from 0.8 to 1.0 gm/cc. In some embodiments, when the float body is configured as a gas float, the density can be a value in a range from 0.5 to 0.8 gm/cc.

One skilled in the pertinent art would understand how the chemical composition of the DCPD thermoset resin would vary the density of DCPD thermoset resin and thereby provide a way to adjust the density of the float body.

Additionally, in some embodiments, to facilitate adjusting the float body's density to a specific value, the float body can further include a density-modifying material. Non-limiting examples of the density-modifying material include one or more of: inorganic fillers, metallic microspheres or inorganic microspheres. Some embodiments of the density-modifying material can have a density ranging from 0.01 to 0.5 gm/cc.

Non-limiting examples of inorganic fillers include talc, calcium carbonate, titanium dioxide, fumed silica, antimony trioxide, or combinations thereof. Non-limiting examples of metallic microspheres include aluminum, zirconium, steel, or carbide hollow shells or combinations thereof. Non-limiting examples of inorganic microspheres include glass, ceramic or silica aerogel microspheres, or combinations thereof.

In some embodiments, at least about 5 wt % (or about 10, 20, 30, 40 or 50 wt % in some embodiments) of the float body is composed of the density-modifying material. Consider as an example, a float body embodiment where the DCPD thermoset resin has a density of 1.05 gm/cc and the density-modifying material (e.g., a silica oxide aerogel) have a density of 0.01 gm/cc. Float bodies composed of DCPD thermoset resin to density-modifying material in ratios of about 50:50, 60:40, 70:30, 80:20, or 90:10 will have densities of about 0.53, 0.67, 0.74, 0.84, or 0.95 gm/cc, respectively.

As further illustrated in FIG. 1, embodiments of the float body 110 can be configured as a one or more valves disposed within a housing 120 of the flow control device 100, e.g., to reduce water production by shutting off flow when water is detected through density changes. For instance, in some embodiments, the flow control device can be configured as an autonomous flow control device (e.g., a passive flow control device not requiring moving components and/or electronics to regulate flow), where the float body or bodies 110 move (e.g., due to being buoyant and rising or floating or non-buoyant and dropping or sinking) in the flow control device housing in response to a change in density of the formation fluid surrounding the float body in the housing, to thereby control the flow of the formation fluid through the housing. For example, the flow control device 100 can be configured in any of the device configurations and be part of any of the wellbore tools (e.g., a control system disposed on production tubing), such as disclosed by Fripp et al., in US application 20200064871, which is incorporated by reference in its entirety.

As a non-limiting example, the float body 110 may be configured as a water float body 110a or a gas float body 110b and have a customized shape and density so as to rotate about a hinge (e.g., hinge 125. As formation fluids (e.g., fluids 130) enter the flow control device 100 through an opening (e.g., inlet opening 132 located between protrusions 135) that allows access to an internal chamber 137 of the housing 120. The fluids 130 can push against the water float body 110a and/or gas float body 110b thereby causing the water float body 110a and/or gas float body 110b to rise due to a density difference, and thereby rotate about the hinge 125. As the water float body 110a and/or gas float body 110b displace due to the introduction of formation fluid 130, a potential flow path that leads to an opening (e.g., outlet opening 140) may become available to the fluid 130.

As a non-limiting example FIG. 2 illustrates a well system 202 which can include any of the embodiments of the flow control device 100 as disclosed herein. As illustrated, well system 202 may include a wellbore 201 that comprises a generally vertical uncased section 210 that may transition into a generally horizontal uncased section through a subterranean formation 215. In some embodiments, the vertical section 210 may extend downwardly from a portion of the wellbore 201 having a string of casing 220 cemented therein. A tubular string, such as production tubing 225, may be installed in or otherwise extended into the wellbore 201.

A plurality of well screens 230, flow control devices 100, and packers 235 can be interconnected along the production tubing 225, such as along portions of the production tubing 112 in vertical or horizontal sections of the wellbore 201. The packers 235 can be configured to seal off an annulus 240 defined between production tubing 225 and the walls of wellbore 201. As a result, formation fluids 130 can be produced from multiple intervals of the surrounding subterranean formation 215 via isolated portions of annulus 240 between adjacent pairs of packers 235.

In some embodiments, a well screen 230 and a flow control device 100 may be interconnected in the production tubing 225 and positioned between a pair of the packers 235. Embodiments of the well screens 230 can be swell screens, wire wrap screens, mesh screens, sintered screens, expandable screens, pre-packed screens, treating screens, or other known screen types. In operation, well screen 230 maybe configured to filter formation fluids 130 flowing into production tubing 225 from annulus 240. Flow control devices 100 can be configured to restrict or otherwise regulate the flow of the fluids 130 into the production tubing 225, based on certain physical characteristics of the fluids, such as density. For some embodiments, such as illustrated in FIG. 1, the flow control device 100 can be a centrifugal fluid selector, where a portion of the centrifugal fluid selector may be actuated to rotate by the flow of fluids 130 and by centrifugal force.

Some embodiments of the flow control device 100 can be an autonomous flow control device and configured to use fluid dynamics and delay the flow of unwanted fluids such as water and/or gas into the interior of production tubing 225. The autonomous flow control device may operate as a passive flow control device, not requiring moving components and/or electronics. The autonomous flow control device may be any suitable shape such as, but not limited to, cross-sectional shapes that are circular, elliptical, triangular, rectangular, square, hexagonal, and/or combinations thereof.

The illustrated well system 202 is merely one example of a wide variety of well systems in which the principles of this disclosure may be utilized. Accordingly, it should be understood that the principles of this disclosure are not necessarily limited to any of the details of the depicted well system 202, or the various components thereof, depicted in the drawings or otherwise described herein. For example, it is not necessary in keeping with the principles of this disclosure for wellbore 201 to include a generally vertical wellbore or horizontal wellbore sections.

Furthermore, it is not necessary that at least one well screen 230 and flow control device 100 be positioned between a pair of packers 235. Nor is it necessary for a single flow control device 100 to be used in conjunction with a single well screen 230. Rather, any number, arrangement and/or combination of such components may be used, without departing from the scope of the disclosure. In some applications, it is not necessary for flow control device 100 to be used with a corresponding well screen 230. For example, in injection operations, an injected fluid could be flowed through flow control device 100, without also flowing through well screen 230.

Those skilled in the art will readily recognize the advantages of being able to regulate the flow of fluids 130 into production tubing 225 from each zone of subterranean formation 245, for example, to prevent water coning or gas coning (e.g., coning 245) in the subterranean formation 215. Non-limiting other example uses for flow regulation in a well system include balancing production from (or injection into) multiple zones, minimizing production or injection of undesired fluids, maximizing production or injection of desired fluids, etc.

FIG. 2 further illustrates an embodiment of the system 202 including a workover rig or truck 250 that supplies the basepipe 255 to which the downhole tool 200 including the flow control device 100 can be attached. The system 202 may include a computer for controlling and monitoring the operations of the tool 200 during the packing operations. E.g., the operator may use a conventional monitoring system to determine when the tool 200 has reached the appropriate depth in the casing 220 of the wellbore 201. When the appropriate depth is reached, as part of the packing operations, polymer seal is caused to swell or expand, and such operation can be conducted on one or more plugging zones in the wellbore 201.

Another embodiment of the present disclosure is a method of manufacturing a flow control device for a wellbore downhole tool. With continuing reference to FIGS. 1-3 throughout, the method 300 includes forming a float body 110 for a flow control device 100 of the wellbore downhole tool 200 (e.g., step 305), the float body including a DCPC thermoset resin and the float body having a density in a range from about 0.6 to about 1.0 and having a volume swelling of 1 percent or less in the presence of a formation fluid produced in the wellbore 201 over a production period of about 2 days or more.

The DCPC thermoset resin formed in step 305 can be any of the embodiments such as described herein.

In some embodiments, the forming of the float body 110 (step 305) includes providing a liquid DCPD monomer (step 310).

In some embodiments, forming the float body 110 (step 305) includes mixing a liquid DCPD monomer and a co-monomer together to form a homogenous liquid pre-polymer mixture (step 312). For instance, the provided co-monomer can be a liquid TCPD monomer and/or any of the other co-monomers, in the proportions, as disclosed, or incorporated by reference, herein.

In some embodiments, forming the float body 110 (step 305) includes mixing a liquid DCPD monomer, or a homogenous liquid pre-polymer mixture including DCPD monomer, (e.g., as formed in step 310 or 312, respectively) with a density-modifying material to form a homogenous density-modified pre-polymer mixture (step 315). For instance, the provided density-modifying material can be any one or more of the density-modifying materials, in the proportions, as disclosed, or incorporated by reference, herein.

In some embodiments, forming the float body 110 (step 305) includes adding an activator (e.g., any one or more of the activators disclosed or incorporated by reference herein) to the liquid DCPD monomer, the liquid pre-polymer mixture or the density-modified pre-polymer mixture (e.g., formed in steps 310, 312 and 315, respectively) to form an activated pre-polymer mixture (step 320).

In some embodiments, the forming of the float body 110 (step 305) includes pouring an activated pre-polymer mixture that includes DCPD monomer (e.g., any of the materials formed in step 320) into a mold (step 325) and then curing the activated pre-polymer mixture (step 327) to cast the activated pre-polymer mixture into the DCPC thermoset resin.

In some such embodiments, the curing of the activated pre-polymer mixture (step 327) can include maintaining the activated pre-polymer mixture while in in the mold at a temperature value in a range of about 20 to 100° C. to, e.g., minimize structural degradation of the added density-modify materials. In some such embodiments, the curing of the activated pre-polymer mixture (step 327) can include low shear mixing of the activated pre-polymer mixture while in the mold (e.g., mixing with a shear stress of about 10 Pa or less, e.g., via a tumbler or shaker apparatus) to, e.g., minimize structural degradation of the added density-modify material (e.g., 20%, 10% or 1% or less breakage of added density-modify material, such as metallic microspheres or inorganic microspheres).

In some such embodiments, an interior of the mold is shaped such that the DCPC thermoset resin when removed from the mold is in a final shape of the float body (step 330), e.g., any of the shapes disclosed or incorporated by reference herein, that can be directly used in the flow control device without further shape-modification.

In some such embodiments, the DCPC thermoset resin in removed from the mold (step 335) and then the DCPC thermoset resin is machined, or otherwise modified, into a final shape of the float body (step 340).

Embodiments of the method 300 can include disposing the float body 110 (e.g., formed in step 305) in a housing 120 of the flow control device 100 (step 350). E.g., the float body is disposed such that the float body can float or sink in the housing in response to a density change in formation fluid 130 surrounding the float body 110 in the housing, to thereby control the formation fluid 130 flow through the housing.

### EXPERIMENTS

Test materials were cast into test float bodies and the material changes of the float bodies were compared between newly manufactured float body in air at room temperature (Orig.) versus after one week of exposure to a simulated production period (Aged) with exposure at 125° C. to test fluids corresponding to calcium bromide brine fluid (e.g., saturated CaBr₂ in water) and to simulated production hydrocarbon fluid (e.g., NACE standard hydrocarbon fluid, Number ______ including a mixture of hexane or heptane, toluene and cyclohexane in ratios of about 70:10:20). The test results, presented in TABLE 1, illustrate the density and volume stability of the float body test samples over the simulated production period.

TABLE 1

| Float | | | Wt - | Wt | | Wt | | Vol |
|---|---|---|---|---|---|---|---|---|
| Body | | Age | Air | H₂O | Hardness | Chg. | | Swell |
| Test No. | Test Fluid | Status | (g) | (g) | (Shr A) | (%) | Density | (%) |
| 1 | CaBr₂ Brine | Orig. | 136.26 | 6.36 | 78.8 | | 1.0490 | |
| | | Aged | 136.16 | 6.20 | 83.7 | −0.073% | 1.0477 | 0.12% |
| | Simulated | Orig. | 136.30 | 6.36 | 81.4 | | 1.0489 | |
| | Hydrocarbon | Aged | 136.16 | 6.20 | 83.5 | −0.103% | 1.0477 | 0.12% |
| 2 | CaBr₂ Brine | Orig. | 136.48 | 7.32 | 81.7 | | 1.0567 | |
| | | Aged | 136.42 | 7.16 | 82.3 | −0.044% | 1.0554 | 0.12% |
| | Simulated | Orig. | 136.28 | 7.38 | 83.0 | | 1.0490 | |
| | Hydrocarbon | Aged | 179.10 | Floats | 46.0 | −0.073% | 1.0477 | .12% |

Disclosure statements.

Statement 1. A flow control device for a wellbore downhole tool, comprising: a float body including a dicyclopentadiene thermoset resin, wherein the float body has a density in a range from about 0.6 to about 1.0 and has a volume swelling of 1 percent or less in the presence of a formation fluid produced in the wellbore over a production period of about 2 days or more.

Statement 2. The device of statement 1, wherein at least about 50 weight percent of the float body is composed of the dicyclopentadiene thermoset resin.

Statement 3. The device of statement 2, wherein the dicyclopentadiene thermoset resin is a homopolymer of dicyclopentadiene.

Statement 4. The device of statement 1, wherein the dicyclopentadiene thermoset resin is a copolymer of dicyclopentadiene and tricyclopentadiene.

Statement 5. The device of statement 4, wherein the float body is configured as a liquid float having the density in a range from about 0.8 to 1.0 gm/cc.

Statement 6. The device of statement 1, wherein the float body is configured as a gas float having the density in a range from about 0.6 to 0.8 gm/cc.

Statement 7. The device of statement 1, wherein at least about 5 weight percent of the float body is composed of the density-modifying material.

Statement 8. The device of statement 7, wherein at least about 5 weight percent of the float body is composed of the density-modifying material.

Statement 9. The device of statement 1, wherein the float body is configured as one or more valves disposed within a housing of the flow control device.

Statement 10. The device of statement 9, wherein the flow control device is configured as an autonomous flow control device, where the float body moves in the housing in response to a change in density of the formation fluid surrounding the float body in the housing, to thereby control the flow of the formation fluid through the housing.

Statement 11. A method of manufacturing method a flow control device for a wellbore downhole tool, comprising: forming a float body for a flow control device of the wellbore downhole tool, the float body including a dicyclopentadiene thermoset resin and the float body having a density in a range from about 0.6 to about 1.0 and having a volume swelling of 1 percent or less in the presence of a formation fluid produced in the wellbore over a production period of about 2 days or more.

Statement 12. The method of statement 11, wherein forming the float body includes providing a liquid dicyclopentadiene monomer.

Statement 13. The method of statement 11, wherein forming the float body includes mixing a liquid dicyclopentadiene monomer and a co-monomer together to form a homogenous liquid pre-polymer mixture.

Statement 14. The method of statement 11, wherein forming the float body includes mixing a liquid dicyclopentadiene monomer, or a homogenous liquid pre-polymer mixture including dicyclopentadiene monomer, with a density-modifying material to form a homogenous density-modified pre-polymer mixture.

Statement 15. The method of statement 11, wherein forming the float body includes mixing a liquid dicyclopentadiene monomer includes adding an activator to the liquid dicyclopentadiene monomer, the liquid pre-polymer mixture or the density-modified pre-polymer mixture to form an activated pre-polymer mixture.

Statement 16. The method of statement 11, wherein forming the float body includes pouring an activated pre-polymer mixture that includes dicyclopentadiene monomer into a mold.

Statement 17. The method of statement 11, further including curing the activated pre-polymer mixture to cast the activated pre-polymer mixture into the DCPC thermoset resin.

Statement 18. The method of statement 17, wherein an interior of the mold is shaped such that the dicyclopentadiene thermoset resin when removed from the mold is in a final shape of the float body.

Statement 19. The method of statement 17, further including removing the dicyclopentadiene thermoset resin from the mold and machining the dicyclopentadiene thermoset resin into a final shape of the float body.

Statement 20. The method of statement 11, further including disposing the float body in a housing 120 of the flow control device.

Those skilled in the art to which this application relates will appreciate that other and further additions, deletions, substitutions and modifications may be made to the described embodiments.

What is claimed is:

1. A flow control device for a wellbore downhole tool, comprising:
a float body including a dicyclopentadiene thermoset resin, wherein the float body has a density in a range from about 0.6 to about 1.0 and has a volume swelling of 1 percent or less in the presence of a formation fluid produced in the wellbore over a production period of about 2 days or more.

2. The device of claim 1, wherein at least about 50 weight percent of the float body is composed of the dicyclopentadiene thermoset resin.

3. The device of claim 1, wherein the dicyclopentadiene thermoset resin is a homopolymer of dicyclopentadiene.

4. The device of claim 1, wherein the dicyclopentadiene thermoset resin is a copolymer of dicyclopentadiene and tricyclopentadiene.

5. The device of claim 1, wherein the float body is configured as a liquid float having the density in a range from about 0.8 to 1.0 gm/cc.

6. The device of claim 1, wherein the float body is configured as a gas float having the density in a range from about 0.6 to 0.8 gm/cc.

7. The device of claim 1, wherein the float body further includes a density-modifying material, the density-modifying material including one or more of: inorganic fillers, metallic microspheres or inorganic microspheres.

8. The device of claim 7, wherein at least about 5 weight percent of the float body is composed of the density-modifying material.

9. The device of claim 1, wherein the float body is configured as one or more valves disposed within a housing of the flow control device.

10. The device of claim 9, wherein the flow control device is configured as an autonomous flow control device, where the float body moves in the housing in response to a change in density of the formation fluid surrounding the float body in the housing, to thereby control the flow of the formation fluid through the housing.

11. A method of manufacturing a flow control device for a wellbore downhole tool, comprising:
forming a float body for a flow control device of the wellbore downhole tool, the float body including a dicyclopentadiene thermoset resin and the float body having a density in a range from about 0.6 to about 1.0 and having a volume swelling of 1 percent or less in the presence of a formation fluid produced in the wellbore over a production period of about 2 days or more.

12. The method of claim 11, wherein forming the float body includes providing a liquid dicyclopentadiene monomer.

13. The method of claim 11, wherein forming the float body includes mixing a liquid dicyclopentadiene monomer and a co-monomer together to form a homogenous liquid pre-polymer mixture.

14. The method of claim 11, wherein forming the float body includes mixing a liquid dicyclopentadiene monomer, or a homogenous liquid pre-polymer mixture including dicyclopentadiene monomer, with a density-modifying material to form a homogenous density-modified pre-polymer mixture.

15. The method of claim 11, wherein forming the float body includes mixing a liquid dicyclopentadiene monomer includes adding an activator to the liquid dicyclopentadiene monomer, the liquid pre-polymer mixture or the density-modified pre-polymer mixture to form an activated pre-polymer mixture.

16. The method of claim 11, wherein forming the float body includes pouring an activated pre-polymer mixture that includes dicyclopentadiene monomer into a mold.

17. The method of claim 11, further including curing the activated pre-polymer mixture to cast the activated pre-polymer mixture into the DCPC thermoset resin.

18. The method of claim 17, wherein an interior of the mold is shaped such that the dicyclopentadiene thermoset resin when removed from the mold is in a final shape of the float body.

19. The method of claim 17, further including removing the dicyclopentadiene thermoset resin from the mold and machining the dicyclopentadiene thermoset resin into a final shape of the float body.

20. The method of claim 11, further including disposing the float body in a housing 120 of the flow control device.
